(19) United States
(12) Patent Application Publication
(10) Pub. No.: US 2010/0312687 A1
(43) Pub. Date: Dec. 9, 2010

(54) Method and System for Facilitating International Investment with Respect to Immigration

(75) Inventor: Yung Yeung, Bradbury, CA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Hybrid Kinetic Motors Corporation, Pasadena, CA (US)

(21) Appl. No.: 12/842,435

(22) Filed: Jul. 23, 2010

Related U.S. Application Data
(63) Continuation-in-part of application No. 12/640,893, filed on Dec. 17, 2009.
Application No. 12/640,893 is a division of application No. 12/511,149, filed on Jul. 29, 2009, now Pat. No. 7,647,253.
Application No. 12/511,149 is a continuation of application No. 12/478,108, filed on Jun. 4, 2009, now Pat. No. 7,716,087.
(60) Provisional application No. 61/228,398, filed on Jul. 24, 2009.

(51) Int. Cl. G06Q 40/00

(52) U.S. Cl. 705/37

(57) ABSTRACT

An internet accessible computer system and methods using the computer system to facilitate international investment among different jurisdictions through a qualified immigration program. In one embodiment, the system has a first client system related to a public company, a second client system related to a first entity, at least one computer server coupled to a database for storing data, and a network connecting said the first client system and the second client system to said at least one computer server.

### CROSS-REFERENCE TO RELATED PATENT APPLICATION

This application claims the benefit, pursuant to 35 U.S.C. §119(e), of U.S. provisional patent application Ser. No. 61/228,398, filed Jul. 24, 2009, entitled “METHOD AND SYSTEM FOR FACILITATING INTERNATIONAL INVESTMENT WITH RESPECT TO IMMIGRATION,” by Yung Yeung, which is incorporated herein by reference in its entirety.

This application is also a continuation-in-part of U.S. patent application Ser. No. 12/640,893, filed on Dec. 17, 2009, entitled “METHODS AND SYSTEM OF CONDUCTING BUSINESS-TO-BUSINESS OPERATIONS BY REGISTERED SELLERS AND BUYERS USING AN INTERNET ACCESSIBLE PLATFORM” by Yung Yeung, which status is pending and is incorporated herein by reference in its entirety which is incorporated herein by reference in its entirety, which is a divisional application of, and claims benefit of U.S. patent application Ser. No. 12/511,149, filed Jul. 29, 2009, entitled “METHODS AND SYSTEM OF CONDUCTING BUSINESS-TO-BUSINESS OPERATIONS BY REGISTERED SELLERS AND BUYERS USING AN INTERNET ACCESSIBLE PLATFORM,” by Yung Yeung, now issued as U.S. Pat. No. 7,647,253, the disclosure of which is hereby incorporated herein in its entirety by reference, and which itself is a continuation application of U.S. application Ser. No. 12/478,108, filed Jun. 4, 2009, entitled “METHODS AND SYSTEM OF CONDUCTING BUSINESS-TO-BUSINESS OPERATIONS BY REGISTERED SELLERS AND BUYERS USING AN INTERNET ACCESSIBLE PLATFORM,” by Yung Yeung, now issued as U.S. Pat. No. 7,716,087, the disclosure of which is hereby incorporated herein in its entirety by reference.

Some references, if any, which may include patents, patent applications and various publications, are cited in a reference list and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### FIELD OF THE INVENTION

The present invention relates generally to international investment between different jurisdictions through qualified immigration program, in particular, to an internet accessible computer system and corresponding methods to facilitate international investment among different jurisdictions through qualified immigration program.

### BACKGROUND OF THE INVENTION

It is known that the United States of America or the United States is one of the world's most ethnically diverse and multicultural nations, the product of large-scale immigration from many countries. Generation after generation, man and woman from different countries and cultures have come to the United States to pursue their happiness, the American Dream. Today, the United States remains as a desired place in the world for people to live. While an influx of new residents from different cultures presents some challenges, “the United States has always been energized by its immigrant populations,” said President Bill Clinton in 1998. Voicing support for immigrants, including immigrants from Asia and Latin America when he said that “America has constantly drawn strength and spirit from wave after wave of immigrants . . . . They have proved to be the most restless, the most adventurous, the most innovative, the most industrious of people.”

Nevertheless, non-residents of the United States cannot automatically become a legal resident of the United States just by showing up in the United States; they have to gain their permanent residence in the United States through at least one of the immigration visa programs administered by the United States.

One such program is called as the Immigrant Investor Program, commonly known as the “EB-5” visa program or simply the EB-5 program. The EB-5 visa for Immigrant Investors is a United States visa created by the Immigration Act of 1990. This visa provides a process of obtaining a green card for foreign nationals who invest money in the United States. To obtain the visa, foreign nationals individually must normally invest at least $1 million, creating at least 10 jobs. However, by investing in certain qualified investments or regional centers with high unemployment rates, the required investment for each foreign national amount is $500,000. The Immigrant Investor Pilot Program was created by Section 610 of Public Law 102-395 on Oct. 6, 1992. This was in accordance to a Congressional mandate aimed at stimulating economic activity and job growth, while allowing eligible aliens the opportunity to become lawful permanent residents. This “Pilot Program” required only $500,000 of investment in exchange for permanent resident status. The investment could only be received by an economic vehicle defined as a Regional Center.

A Regional Center is defined as any economic unit, public or private, that engaged in the promotion of economic growth, improved regional productivity, job creation and increased domestic capital investment. The individual receiving the EB-5 visa is not required to actively manage the business invested in. For investors who wish to invest in a new or existing business, have an active role in the management of the operation (although simply being a Limited partner in the organization that owns the business qualifies as “an active role”), and have at least $1,000,000 to invest ($500,000 if the business is located in certain areas deemed as rural or with very high unemployment), then the traditional EB-5 visa is the best option for potential investors who want to become a permanent resident of the United States.

Due to the constant need of job growth and economic growth, it is desired that the EB-5 visa program can be fully utilized.

However, the lack of suitable large scale investment projects limits the participation of potential foreign investors—traditional “Mama and Papa” business is not attractive due to its instability, sustainability and lack of transparency. Moreover, because only capital placed at risk for purposes of job-creation within the 2-year period will be counted as part of the investment funds per the EB-5 visa program, potential foreign investors face a daunting challenge to find an investment project that qualifies under the EB-5 visa program and still offers a reasonable expectation of investment return.

Therefore, a heretofore unaddressed need exists in the art to address the aforementioned deficiencies and inadequacies.

### SUMMARY OF THE INVENTION

The present invention, in one aspect, relates to a method of facilitating international investment among different jurisdictions through a qualified immigration program. In one embodiment, the method includes the steps of:

qualifying one or more investors from a first jurisdiction;

receiving a first cash or cash equivalents payments in the amount of V₁ made by one or more qualified investors;

making book entries on an internet accessible computer server for the cash or cash equivalents payments received and storing corresponding records of the book entries in a database coupled with the computer server;

offering a first type of security to one or more qualified investors from the first jurisdiction by a first entity in a second jurisdiction that is different from the first jurisdiction;

subscribing the first type of security by one or more qualified investors from the first jurisdiction or other jurisdictions that are not the second jurisdiction;

receiving a second cash or cash equivalents payments in the amount of V₂ from the offering by the first entity, wherein the second cash or cash equivalents payments are made by said one or more qualified investors or their representatives, and wherein V₁, V₂ satisfy the following relationship:

V₁≦V₂, and V₁≦V₀≦V₂,

wherein V₀ is an amount that is predetermined by the government of the second jurisdiction;

making book entries on a computer server for the second cash or cash equivalents payments received and storing corresponding records of the book entries in a database coupled with the computer server;

investing a portion of the received cash or cash equivalents payments in the amount of V₀ for each qualified investor in a project in the second jurisdiction by the first entity;

for each of said one or more qualified investors, applying for investment-based immigration program in the second jurisdiction allowed by the government of the second jurisdiction with a first petition;

making book entries on the computer server for the first petition for each of said one or more qualified investors and storing corresponding records of the book entries in the database coupled with the computer server;

if the first petition is disapproved by the government of the second jurisdiction for a qualified investor, making a cash or cash equivalents payment in the amount of V₂ to said disapproved qualified investor;

making book entries on the computer server for the payment to said disapproved qualified investor and storing corresponding records of the book entries in the database with a first flag;

if the first petition is approved by the government of the second jurisdiction for a qualified investor, making a second petition to the government of the second jurisdiction for said approved qualified investor;

making book entries on the computer server for said approved qualified investor and storing corresponding records of the book entries in the database with a second flag;

counting the total number of the second flag, F, by the computer server;

periodically calculating by the computer server a total investment amount V by the following formula:

V=F×V₀;

receiving request from one or more approved qualified investors to exchange the first security for a second type of security of a public company at a predetermined date;

checking by the computer server if there is a second flag corresponding to an approved qualified investor who has made the request and granting the request only if there is a second flag corresponding to the approved qualified investor;

delivering said second type of security of a public company in the first jurisdiction to said approved qualified investor;

making book entries on the computer server for said approved qualified investor and storing corresponding records of the book entries in the database for the delivery; and

repeating the last three steps until all the requests from one or more approved qualified investors are processed.

The second jurisdiction is a country or region that has a government offering an investment-based immigration program, and the first jurisdiction is a country or region that is different from the first jurisdiction. The first jurisdiction is a country or region that is not the United States.

In one embodiment, the second jurisdiction is the United States, and the investment-based immigration program is the EB-5 program. The first jurisdiction is one of China, Russia, Mexico, India, South Korea, Taiwan, Dubai and Hong Kong. In one embodiment, V₀ equals to one of $500,000 and $1,000,000, which is currently required by the EB-5 program and may be modified over time by the government of the United States. For the EB-5 program, the first petition is an I-526 petition defined in the EB-5 program and the second petition is an I-829 petition defined in the EB-5 program, which again may be modified over time by the government of the United States.

The first entity is one of a company, a partnership, a limited liability company, a limited liability partnership, a limited company, and a limited partnership.

In one embodiment, the first type of security is one of stocks of a company, a limited liability company or a limited company, and units in a partnership, a limited liability partnership or a limited partnership. The second type of security is stocks of the public company, wherein the public company is listed in a stock exchange of one of the first jurisdiction, the second jurisdiction, and a third jurisdiction. In one embodiment, the public company is listed in a stock exchange of China. Alternatively, the public company may also be listed in a stock exchange of Hong Kong.

In one embodiment, the predetermined date for an approved qualified investor corresponds to a date that is five (5) years from the date when the second cash or cash equivalents payments are made by said approved qualified investor or his or her representative. The predetermined date can be another date chosen by the first entity or a date agreed upon by relevant parties.

In one embodiment, the second jurisdiction is one of Canada, Australia, New Zealand, and North Ireland.

The present invention, in another aspect, relates to an internet accessible computer system to facilitate international investment among different jurisdictions through a qualified immigration program. In one embodiment, the system has a first client system 202 related to a public company, a second client system 216 related to a first entity, at least one computer server 219 coupled to a database 219a for storing data, and a network 228 connecting said the first client system 202 and the second client system 216 to said at least one computer server 219.

In one embodiment, said at least one computer server 219 is programmed for:

(a) making book entries on an internet accessible computer server for a first cash or cash equivalents payments received in the amount of V₁ made by one or more investors from a first jurisdiction and storing corresponding records of the book entries in a database 219a coupled with the computer server to qualify said one or more investors;

(b) after a first type of security is offered to one or more qualified investors from the first jurisdiction by the first entity in a second jurisdiction that is different from the first jurisdiction, making book entries through the second client system 216 on the computer server 219 and storing corresponding records of the book entries in the database 219a coupled with the computer server;

(c) after the first type of security is subscribed by one or more qualified investors from the first jurisdiction, making book entries through the second client system 216 on the computer server 219 and storing corresponding records of the book entries in the database 219a coupled with the computer server;

(d) after a second cash or cash equivalents payments in the amount of V₂ from the offering is received by the first entity, wherein the second cash or cash equivalents payments are made by said one or more qualified investors or their representatives, and wherein V₁, V₂ satisfy the following relationship:

V₁≦V₂, and V₁≦V₀≦V₂,

wherein V₀ is an amount that is predetermined by the government of the second jurisdiction, making book entries through the second client system 216 on the computer server 219 and storing corresponding records of the book entries in the database 219a coupled with the computer server;

(e) after investing a portion of the received cash or cash equivalents payments in the amount of V₀ for each qualified investor in a project in the second jurisdiction by the first entity, and an application for each of said one or more qualified investors for investment-based immigration program in the second jurisdiction allowed by the government of the second jurisdiction is filed with a first petition, making book entries on the computer server for the first petition for each of said one or more qualified investors and storing corresponding records of the book entries in the database coupled with the computer server;

(f) after making a cash or cash equivalents payment in the amount of V₂ to said disapproved qualified investor if the first petition is disapproved by the government of the second jurisdiction for a qualified investor, making book entries on the computer server for the payment to said disapproved qualified investor and storing corresponding records of the book entries in the database with a first flag;

(g) after making a second petition to the government of the second jurisdiction for said approved qualified investor if the first petition is approved by the government of the second jurisdiction for a qualified investor, making book entries on the computer server for said approved qualified investor and storing corresponding records of the book entries in the database with a second flag;

(h) counting the total number of the second flag, F, by the computer server;

(i) periodically calculating by the computer server a total investment amount V by the following formula:

V=F×V₀;

(j) after receiving request from one or more approved qualified investors to exchange the first security for a second type of security of a public company at a predetermined date, checking by the computer server if there is a second flag corresponding to an approved qualified investor who has made the request and granting the request only if there is a second flag corresponding to the approved qualified investor;

(k) after said second type of security of a public company in the first jurisdiction is delivered to said approved qualified investor, making book entries on the computer server for said approved qualified investor and storing corresponding records of the book entries in the database for the delivery; and

(l) repeating steps (j) and (k) until all the requests from one or more approved qualified investors are processed.

The present invention, in a further aspect, relates to a method of facilitating international investment among different jurisdictions through a qualified immigration program. In one embodiment, the method includes the steps of:

qualifying one or more investors from a first jurisdiction;

receiving a first cash or cash equivalents payments in the amount of V₁ made by one or more qualified investors;

offering a first type of security to one or more qualified investors from the first jurisdiction by a first entity in a second jurisdiction that is different from the first jurisdiction;

providing the first type of security to one or more qualified investors from the first jurisdiction for subscription;

receiving a second cash or cash equivalents payments in the amount of V₂ from the offering by the first entity, wherein the second cash or cash equivalents payments are made by said one or more qualified investors or their representatives, and wherein V₁, V₂ satisfy the following relationship:

V₁≦V₂, and V₁≦V₀≦V₂,

wherein V₀ is an amount that is predetermined by the government of the second jurisdiction;

investing a portion of the received cash or cash equivalents payments in the amount of V₀ for each qualified investor in a project in the second jurisdiction by the first entity;

for each of said one or more qualified investors, applying for investment-based immigration program in the second jurisdiction allowed by the government of the second jurisdiction with a first petition;

if the first petition is disapproved by the government of the second jurisdiction for a qualified investor, making a cash or cash equivalents payment in the amount of V₂ to said disapproved qualified investor;

making book entries on the computer server for the payment to said disapproved qualified investor and storing corresponding records of the book entries in the database with a first flag;

if the first petition is approved by the government of the second jurisdiction for a qualified investor, making a second petition to the government of the second jurisdiction for said approved qualified investor;

making book entries on the computer server for said approved qualified investor and storing corresponding records of the book entries in the database with a second flag;

periodically calculating by the computer server a total investment amount V by the following formula:

V=F×V₀;

wherein F is the total number of the second flag counted by the computer server;

after receiving request from one or more approved qualified investors to exchange the first security for a second type of security of a public company at a predetermined date, checking by the computer server if there is a second flag corresponding to an approved qualified investor who has made the request and granting the request only if there is a second flag corresponding to the approved qualified investor;

delivering said second type of security of a public company in the first jurisdiction to said approved qualified investor;

making book entries on the computer server for said approved qualified investor and storing corresponding records of the book entries in the database for the delivery; and

repeating the last three steps until all the requests from one or more approved qualified investors are processed.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

FIG. 1 is a block diagram of parties and information/cash flows in an international investment in relation with a government qualified immigration program with help from an inventive computer system according to one embodiment of the present invention.

FIG. 2 is a block diagram of an inventive computer system in relation to relevant parties according to one embodiment of the present invention.

FIG. 3 is a flow chart showing an international investment transaction procedure or method in relation to a qualified immigration program according to one embodiment of the present invention.

FIG. 4 illustrates an exemplary network environment in which an inventive e-commerce platform according to one embodiment of the present invention is utilized to facilitate international investment among different jurisdictions through a qualified immigration program, where each of FIGS. 4A, 4B, 4C and 4D shows a part of the procedure or method, respectively.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which has no influence on the scope of the invention. Additionally, some terms used in this specification are more specifically defined below.

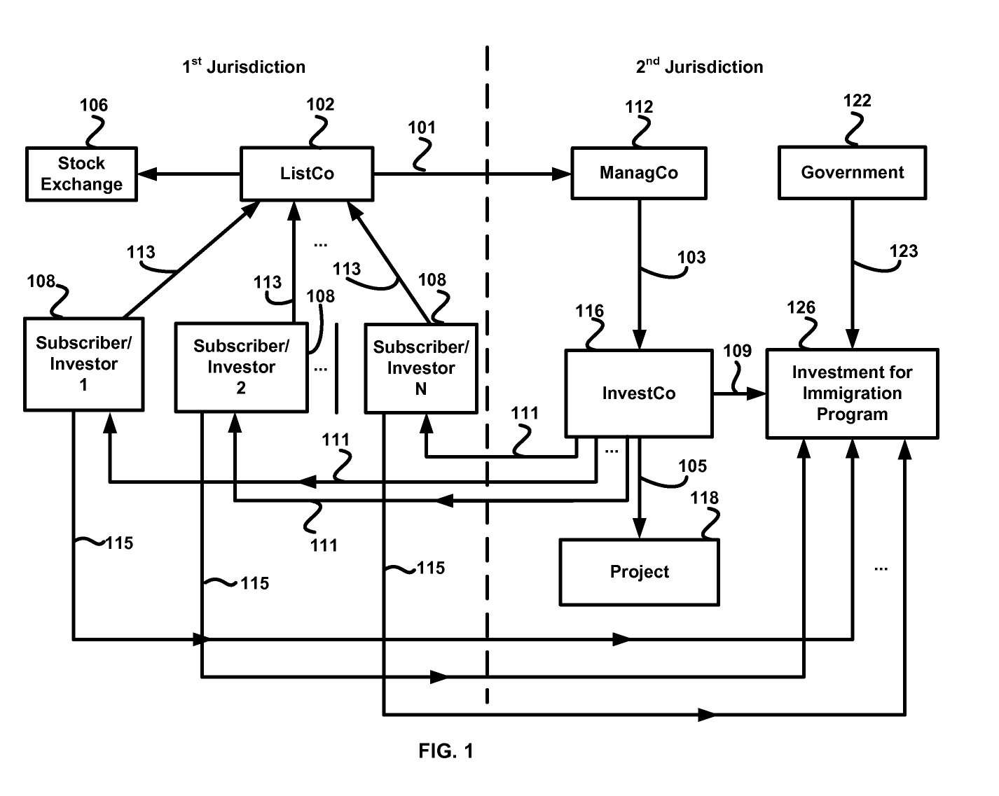

Various unique features of the present invention will be made as to the embodiments of the present invention in conjunction with the accompanying drawings in FIGS. 1-4.

### DEFINITIONS

The terms used in this specification generally have their ordinary meanings in the art, within the context of the invention, and in the specific context where each term is used.

Certain terms that are used to describe the invention are discussed below, or elsewhere in the specification, to provide additional guidance to the practitioner in describing the apparatus and methods of the invention and how to make and use them. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the invention or of any exemplified term. Likewise, the invention is not limited to various embodiments given in this specification. Furthermore, subtitles may be used to help a reader of the specification to read through the specification, which the usage of subtitles, however, has no influence on the scope of the invention.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

### OVERVIEW OF THE INVENTION

The present invention in one aspect relates to a method of facilitating international investment among different jurisdictions through a qualified immigration program. In one embodiment, the method includes the steps of offering a first type of security to one or more investors from a first jurisdiction or other jurisdictions by a first business entity or first entity in a second jurisdiction, subscribing the first type of security by one or more investors from the first jurisdiction or other jurisdictions that are not the second jurisdiction, receiving the proceeds (capital, or cash or cash equivalents) from the offering by the first business entity or first entity, and investing the proceeds in a project in the second jurisdiction by the first business entity or first entity, which creates job opportunities for residents in the second jurisdiction and may stimulate the growth of economy in the second jurisdiction. The method further includes the step of applying for the one or more investors for investment-based immigration program in the second jurisdiction allowed by the government of the second jurisdiction. The method further includes the step of exchanging the first security by the one or more investors for a second type of security of a public company at a predetermined date. The method further includes the step of facilitating by the first business entity or first entity the application of the one or more investors for investment-based immigration program in the second jurisdiction allowed by the government of the second jurisdiction.

In one embodiment, the first business entity or first entity is a limited liability company that is managed by a second company in the second jurisdiction, where the second company is wholly owned by the public company, which may be listed in a stock exchange in one of the first jurisdiction, the second jurisdiction, and a third jurisdiction that is neither the first jurisdiction nor the second jurisdiction.

In one embodiment, the first jurisdiction is the People's Republic of China (“China”), and the second jurisdiction is the United States of America (“USA”). The investment-based immigration program allowed by the government of the United States of America is called EB-5 program.

In another embodiment, the first jurisdiction is the Hong Kong Special Administrative Region of the People's Republic of China (“Hong Kong”), and the second jurisdiction is the United States of America (“USA”). The investment-based immigration program allowed by the government of the United States of America is called EB-5 program. The public company listed in the Hong Kong Stock Exchange is called Listco, the first business entity or first entity in the USA is called Investco, and the second company in the US is called Managco.

The one or more investors may come from Hong Kong, China, Korea, Russia, or any jurisdictions that are not the USA.

In one embodiment, the second jurisdiction can be the USA, Hong Kong, Singapore, Japan, Taiwan, Australia, Canada, or any jurisdictions that offer investment-based immigration program to people or investors from other jurisdictions. The first jurisdiction is a jurisdiction that is different from the second jurisdiction.

In one embodiment, the first type of security is non-voting preferred stocks or stocks of the first business entity or first entity or a partnership interest of the first business entity or first entity if it is a partnership, a limited partnership or a limited liability partnership, which cannot be traded publicly at the time of offering, and the second type of security is stocks of the public company.

The present invention in another aspect relates to a system of facilitating international investment among different jurisdictions through a qualified immigration program. In one embodiment, the system includes a controller programmed to administer a method with the steps of offering a first type of security from a first jurisdiction or other jurisdictions by a first business entity or first entity in a second jurisdiction, subscribing the first type of security by one or more investors from a first jurisdiction or other jurisdictions that are not the second jurisdiction, receiving the proceeds (capital, or cash or cash equivalents) from the offering by the first business entity or first entity, and investing the proceeds in a project in the second jurisdiction by the first business entity or first entity. The method further includes the step of applying for each of the one or more investors for investment-based immigration program in the second jurisdiction allowed by the government of the second jurisdiction. The method further includes the step of exchanging the first security by the one or more investors for a second type of security of a public company in the first jurisdiction at a predetermined date. The method further includes the step of facilitating by the first business entity or first entity the application of the one or more investors for investment-based immigration program in the second jurisdiction allowed by the government of the second jurisdiction. The system also has a database in communication with the controller for storing relevant information and data.

In one embodiment, the controller through a communication network such as the Internet is in communication with the Listco, Managco, Investco, the Government, and the Project by corresponding interfaces, respectively. The Listco, Managco, Investco, the Government, and the Project each may have its own local system and database.

In one embodiment, the controller is programmed to allow investors to access it through a communication network such as the Internet for checking and monitoring their investment and immigration application program, and communicating with the administrators, respectively.

In one embodiment, the controller through a communication network such as the Internet is in communication with one or more service firms such as law firm, accounting firm, etc, which provide professional service to related parties including the Listco, Managco, Investco, the Project and the investors. The one or more service firms each may have its own local system and database.

Now referring to FIG. 1, a block diagram partially showing the parties involved in the method and system according to one embodiment of the present invention is provided.

In a first jurisdiction such as Hong Kong, a Listco 102 is conducting business and has established a wholly owned company Managco 112 in a second jurisdiction such as the USA, which is different form the first jurisdiction. An Investco 116 in the second jurisdiction sets up a Project 118 or Project A that is a qualified project under an investment for immigration program 126 allowed and administered by the government 122 of the second jurisdiction. In the example of the USA as the second jurisdiction, such an investment for immigration program 126 is called the EB-5 program that is allowed and administered by the US government. The Investco 116 may be managed by a Managco 112, which is a subsidiary company in the second jurisdiction and wholly owned by the Listco 102, and functions as a manager of the Investco 116. The Investco 116 and the Managco 112, alternatively, may be a single company. The term “company” used here refers to a business entity that can be a corporation, a partnership, a limited corporation or company, a limited partnership, a limited liability corporation or company (“LLC”), or a limited liability partnership (“LLP”), or any entity can lawfully conduct business in the second jurisdiction. In one embodiment, the Program can be an automobile operation.

The Investco 116 offers a first type of security through a process 111 to investors 108 (investor 1, investor 2, . . . , investor N, N is an integer greater than one) who are not but want to become lawful permanent residents or citizens of the second jurisdiction for the investors to subscribe. Investors 108 may be from the first jurisdiction or other jurisdictions such as China, Hong Kong, Taiwan, Korea, Russia, Mexico, and other countries/regions that are not part of the United States. The Investco 116 uses the proceeds of the offering to invest in the Project 118 through a process 105, which qualifies the investors 108 to apply for immigration to the second jurisdiction through the investment for immigration program through a process 115. The Investco 116 facilitates the immigration applications of the investors 108 with the Government 122 through a process 109 by creating job opportunities for residents in the second jurisdiction, stimulating the growth of economy in the second jurisdiction, and providing necessary documents, statistics and evidences showing same to the Government 122 to facilitate the immigration process for qualified investors. At a predetermined date or maturity date, the investors 108 can exchange the first type of security for a second type of security offered by the Listco 102 through a process 113. The investors can cash out by selling the second type of security or hold on to the second type of security, which allows the investors to access the stock market 106 where the Listco 102 is listed and enjoy potential capital gain from the stock market 106.

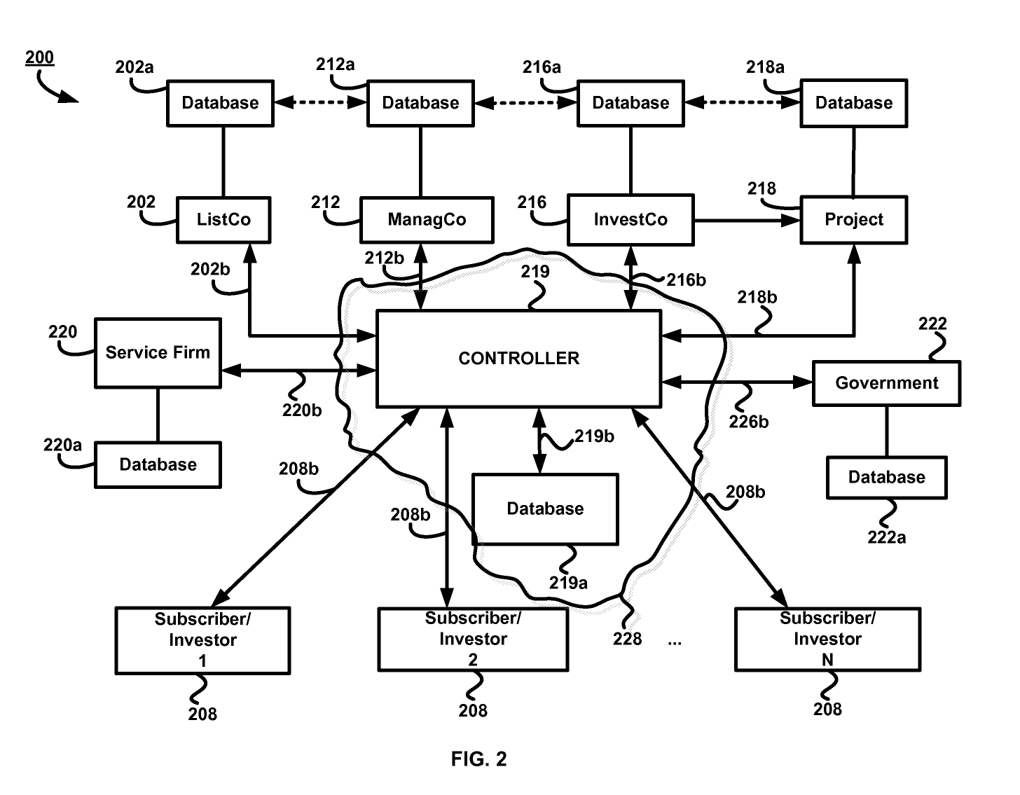

Referring now to FIG. 2, a system 200 of facilitating international investment among different jurisdictions through a qualified immigration program is shown according to one embodiment of the present invention. In one embodiment, the system 200 has a controller 219 programmed to administer a method with the steps of offering a first type of security by a first business entity or first entity 216 (Investco) in a second jurisdiction, subscribing the first type of security by one or more investors 208 from a first jurisdiction or other jurisdictions that are not the second jurisdiction, receiving the proceeds from the offering by the first business entity or first entity 216, and investing the proceeds in a project 218 in the second jurisdiction by the first business entity or first entity 216.

The system 200 also has a database 219a in communication with the controller 219 for storing relevant information and data.

In one embodiment, the controller 219 through a communication network 228 such as the Internet is in communication with the Listco 202, Managco 212, Investco 216, the Government 222, and the Project 218 by corresponding interfaces 202b, 212b, 216b, 222b, 218b with proper hardware and software, respectively. The Listco 202, Managco 212, Investco 216, the Government 222, and the Project 218 each may have its own local system and associated database 202a, 212a, 216a, 222a, 218a, respectively.

In one embodiment, the controller 219 is programmed to allow investors 208 to access it through interfaces 208b connected to a communication network such as the Internet for checking and monitoring their investment and immigration application program, and communicating with the administrators.

In one embodiment, the controller 219 through a communication network 228 such as the Internet is in communication with one or more service firms 220 such as law firm, accounting firm, etc., which may provide professional service to related parties including the Listco 202, Managco 212, Investco 216, the Project 218 and the investors 208. The one or more service firms each may have its own local system and database 202a.

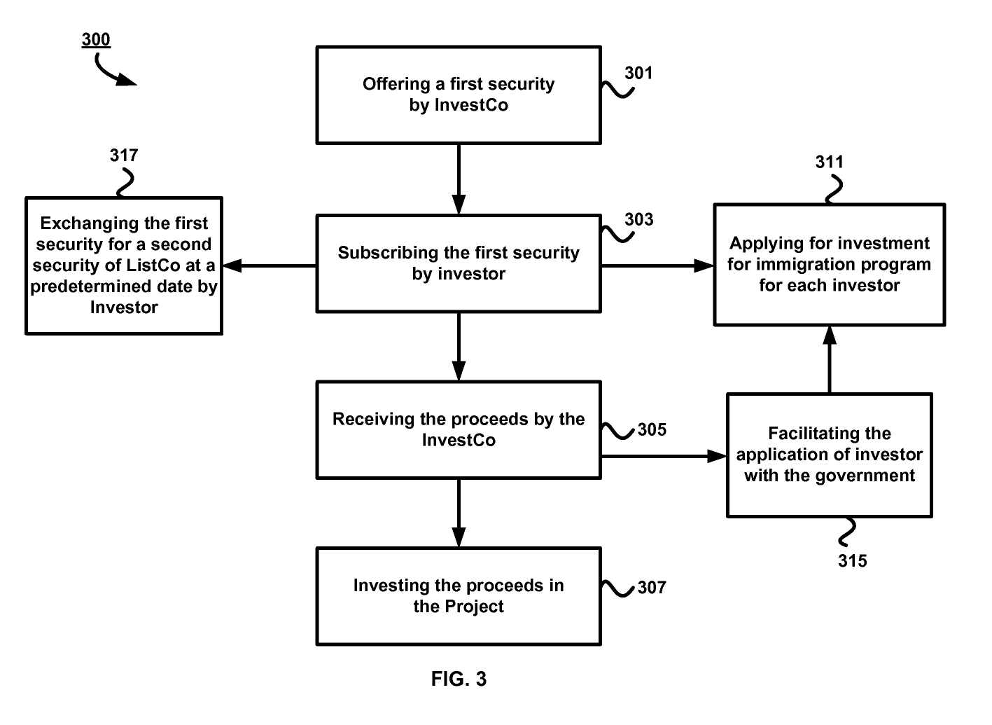

Referring now to FIG. 3, a method 300 of facilitating international investment among different jurisdictions through a qualified immigration program is shown according to one embodiment of the present invention. In one embodiment, the method includes the steps of offering a first type of security one or more investors from a first jurisdiction or other jurisdictions by a first business entity or first entity such as Investco in a second jurisdiction at step 301, subscribing the first type of security by one or more investors from a first jurisdiction or other jurisdictions that are not the second jurisdiction at step 303, receiving the proceeds from the offering by the first business entity or first entity such as Investco at step 305, and investing the proceeds in a project such as project 218 in the second jurisdiction by the first business entity or first entity such as Investco at step 307. The method further includes the step of applying for investment-based immigration program in the second jurisdiction allowed by the government of the second jurisdiction, for each of the one or more investors at step 311. Where the second jurisdiction is the United States, the investment-based immigration program allowed by the government of the United States of America is called EB-5 program.

Still referring to FIG. 3, the method further includes the step of exchanging the first security by the one or more investors for a second type of security of a public company in the first jurisdiction at a predetermined date at step 317. The method further includes the step of facilitating by the first business entity or first entity the application of the one or more investors for investment-based immigration program in the second jurisdiction allowed by the government of the second jurisdiction at step 315. In doing so, the first entity may provide necessary documents, statistics and evidences, showing that the project creates job opportunities for residents in the second jurisdiction, and thus stimulates the growth of economy in the second jurisdiction, to the Government 122, which is made possible by the investment from the investors. It is noted that in practicing methods provided by the present invention, the order of the steps may be changed.

Thus, practicing the methods set forth above in various embodiments of the present invention is advantageous at least because all relevant parties are “winners” or benefited from such a process—using the United States as the second jurisdiction as a example: the investors not only become legal residents of the United States for them to pursue their American Dream, but also may have reasonable return from their investment by having securities such as stocks of the public company, which may not only allow investors to have access to the stock markets such as the Stock Exchange 106, but also enjoy potential returns by the Stock Exchange 106 through the public company as a business and financial vehicle; the public company increases the liquidity of its stocks by having more shareholders holding more shares of it; the first entity gets the needed capital or investment to move Project A forward; and American people are the biggest winner by having more job opportunities offered by Project A, more economic growth through the investment, and new blood and talent to the population as these investors and their families join the American Melting Pot.

Accordingly, the present invention provides methods and system that facilitates international investment among different jurisdictions through a qualified immigration program.

Various unique features of the present invention will be made as to the embodiments of the present invention in conjunction with the accompanying drawings in FIGS. 1-4.

These and other aspects of the present invention are further described below.

### Examples and Implementations of the Invention

Without intent to limit the scope of the invention, exemplary methods and their related results according to the embodiments of the present invention are given below. Note again that titles or subtitles may be used in the examples for convenience of a reader, which in no way should limit the scope of the invention. Moreover, certain theories are proposed and disclosed herein; however, in no way they, whether they are right or wrong, should limit the scope of the invention.

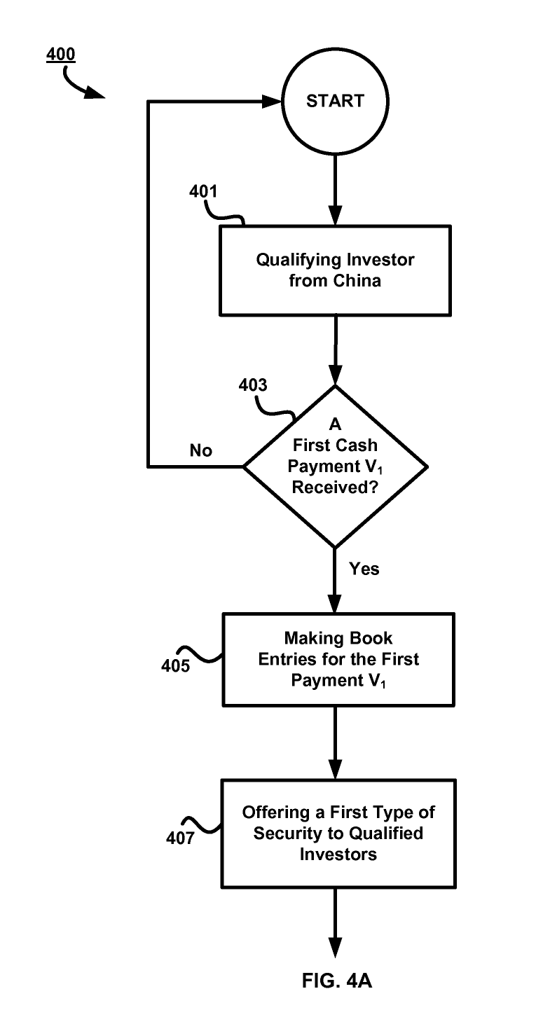

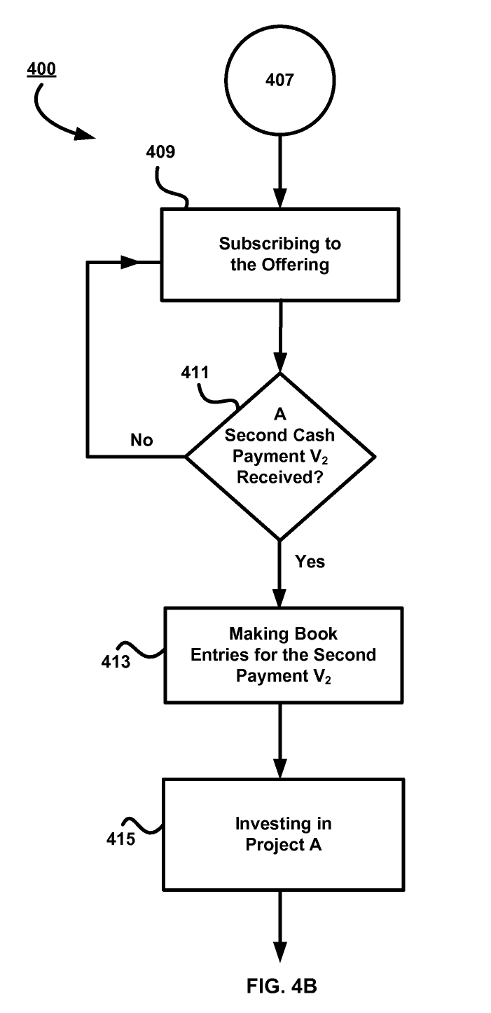

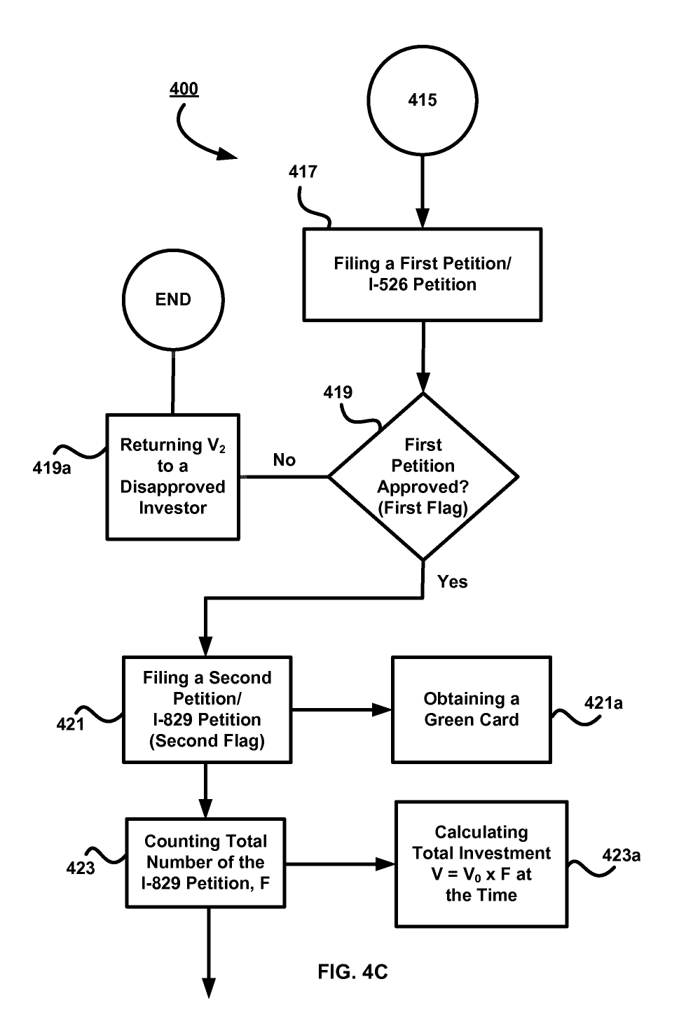

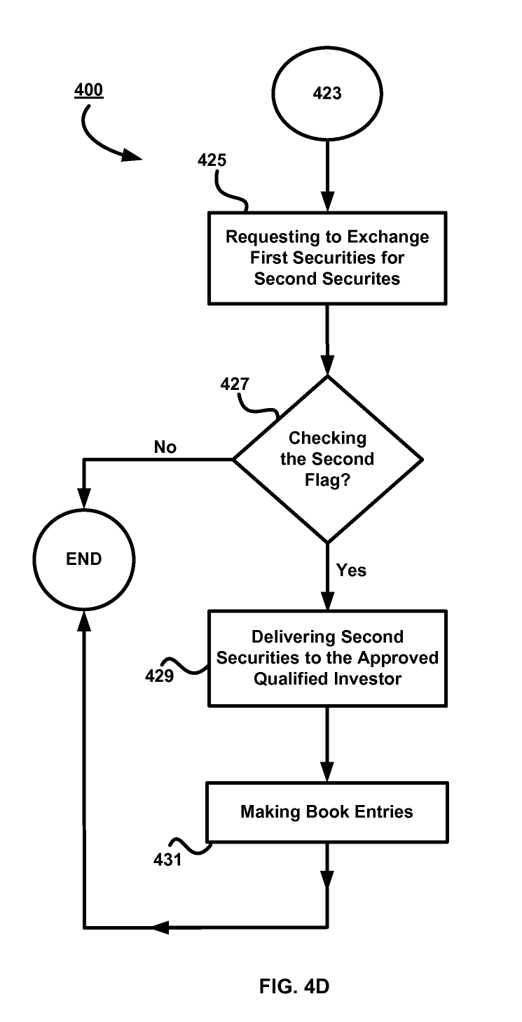

In one exemplary embodiment of the present invention, referring now to FIG. 4, a flow diagram illustrating a procedure or method 400 of facilitating international investment among different jurisdictions through a qualified immigration program, more specifically, to perform a complete process for facilitating international investment among the United States, China and Hong Kong through the EB-5 program, a qualified immigration program offered by the United States, by utilizing the inventive internet accessible platform or computer server 219 is shown. Some of the steps disclosed below have been also discussed in more details in sections set forth above.

At step 401, one or more investors from a first jurisdiction such as China are qualified. The qualification process involves getting relevant information, such as official name, family member information, age, etc., from the investors and verifying the information. It is normally done by asking an investor to fill an information sheet form, which can be filled over the internet through the interface 208b or on a printed copy. The information then can be saved in database 219a. The qualification process also involves asking an investor make a first cash or cash equivalents payments in the amount of V₁ as a deposit, which can be later credited towards to a required amount of the investment.

At step 403, whether a first cash or cash equivalents payments in the amount of V₁ made by one or more qualified investors is checked. If it is received from an investor, this particular investor person will be deemed as a qualified investor; otherwise, this particular investor will be deemed as a non-qualified investor at this time and will be referred back to start the process. In one embodiment, the deposit is in the amount of V₁=$5,000.

At step 405, for a qualified investor who has made the first payment, corresponding book entries are made on an internet accessible computer server 219 for the cash or cash equivalents payments received and corresponding records of the book entries are stored in a database 219a coupled with the computer server 219.

At step 407, a first type of security is offered to one or more qualified investors from the first jurisdiction, here China, by a first entity, here InvestCo 116, in a second jurisdiction that is different from the first jurisdiction, here the United States. The first entity in general can be one of a company, a partnership, a limited liability company, a limited liability partnership, a limited company, and a limited partnership. In one embodiment, the first type of security is one of stocks of a company, a limited liability company or a limited company, and one or more units in a partnership, a limited liability partnership or a limited partnership.

In general, the second jurisdiction is a country or region, such as the United States, that has a government offering an investment-based immigration program, and the first jurisdiction is a country or region that is different from the second jurisdiction, such as China. The first jurisdiction is a country or region that is not the United States.

At step 409, the first type of security are subscribed by one or more qualified investors from the first jurisdiction or other jurisdictions that are not the second jurisdiction. The subscription is done by one or more qualified investors receiving, reviewing and executing necessary documents in the offering package provided by InvestCo 116 as an example, which may include a private placement memo, a limited partnership agreement if InvestCo 116 is set up as a limited partnership, purchase agreement, business plan for a project or Project A to which InvestCo 116 plans to invest the proceeds from the offering, and other documents.

At step 411, whether a second cash or cash equivalents payments in the amount of V₂ from the offering by the first entity from said one or more qualified investors or their representatives is checked, where V₁, V₂ satisfy the following relationship:

V₁≦V₂, and V₁≦V₀≦V₂,

wherein V₀ is an amount that is predetermined by the government of the second jurisdiction.

In the exemplary embodiment, the second jurisdiction is the United States, and the investment-based immigration program is the EB-5 program. The first jurisdiction is one of China, Russia, Mexico, India, South Korea, Taiwan, Dubai and Hong Kong. In one embodiment, V₀ equals to one of $500,000 and $1,000,000, which is currently required by the EB-5 program and may be modified over time by the government of the United States. In one particular, exemplary embodiment, the invention is practiced in association with a regional center, and thus, the investment required by the EB-5 program is V₀=$500,000. V₁ and V₂ are chosen such that V₁=$5,000, and V₂=$545,000. For V₂=$545,000, an amount of V₀=$500,000 will be taken to be invested in a qualified project, and the balance of V₂=$545,000, here $45,000, will be used to pay the government filing fees and transactional costs including copy, mail, professional service fees, and other similar expenses.

At step 413, corresponding book entries on a computer server for the second cash or cash equivalents payments received from one or more qualified investors are entered and corresponding records of the book entries in a database 219a coupled with the computer server 219 are stored and updated for the one or more qualified investors who have made the second cash or cash equivalents payments.

At step 415, a portion of the received cash or cash equivalents payments in the amount of V₀ for each qualified investor is invested in a project in the second jurisdiction by the first entity. In one particular, exemplary embodiment set forth above, where the invention is practiced in association with a regional center, an amount of V₀=$500,000 will be invested in a qualified project, named as Project A, corresponding to one qualified investor. If there are N number qualified investors who have paid the second cash or cash equivalents payments, the total amount of N×V₀ (=$500,000)=0.5×N $million will be invested in a qualified project. It is noted that the investment would be a rolling process as known to people skilled in the business world.

At step 417, for each of said one or more qualified investors who have paid the second cash or cash equivalents payments, an application for investment-based immigration program in the second jurisdiction allowed by the government of the second jurisdiction is made with a first petition. For the EB-5 program, the first petition for each of said one or more qualified investors who have paid the second cash or cash equivalents payments is an I-526 petition as defined in the EB-5 program and required.

At step 419, book entries are entered on the computer server 219 for the first petition for each of said one or more qualified investors and corresponding records of the book entries in the database 219a coupled with the computer server 219 are stored. Once the first petition is received by the Government, here an I-526 petition, proper government branches will review and examine the petition and associated documents. If the first petition, here an I-526 petition, is disapproved by the government of the second jurisdiction for a qualified investor, a cash or cash equivalents payment in the amount of V₂ is returned to said disapproved qualified investor, at step 419a, by the entity has received the cash or cash equivalents payment in the amount of V₂ in the first place. In one particular, exemplary embodiment set forth above, after the I-526 petition for a particular qualified investor is denied, an amount of V₂=$545,000 will be returned to the particular qualified investor. Then, book entries are made on the computer server 219 for the payment to said disapproved qualified investor and corresponding records of the book entries are entered in the database 219a with a first flag.

At step 421, if the first petition is approved by the government of the second jurisdiction for a qualified investor, a second petition to the government of the second jurisdiction for that approved qualified investor will be filed with the government. In one particular, exemplary embodiment set forth above, after the I-526 petition for a particular qualified investor is approved by the U.S. Government, the qualified investor with his or her family, at step 421a, may go through some procedures and steps such as interview by a U.S. Government immigration officer from an oversea branch such as an Embassy or Consulate, health examination, etc., and/or provide documentations such as bank statements, tax return forms, personal identification documents, etc., both of which are required by the U.S. Government. Then a conditional permanent residence will be granted to the approved qualified investor and his or her direct family members for them to come to the United States. The second petition, which is an I-829 petition defined in the EB-5 program, will be filed subsequently with the U.S. Government to request a permanent residence to be granted from the conditional permanent residence. The classification of the petitions, procedures and the requirements for the EB-5 program may be modified over time by the government of the United States. When or after the second petition is filed, book entries are made on the computer server for said approved qualified investor and corresponding records of the book entries are stored in the database with a second flag.

At step 423, the total number of the second flag, F, are counted by the computer server 219.

At step 423a, the computer server 219 periodically calculates a total investment amount V by the following formula:

V=F×V₀,

which would provide proper accounting for the management of the InvestCo 216.

At step 425, at a predetermined date, request or requests from one or more approved qualified investors are received to exchange the first security for a second type of security of a public company. The one or more approved qualified investors may do so because they have made proper investment, secured permanent residence in the United States, and need to move on. In one embodiment, the predetermined date for an approved qualified investor corresponds to a date that is five (5) years from the date when the second cash or cash equivalents payments are made by said approved qualified investor or his or her representative. The predetermined date can be another date chosen by the first entity or a date agreed upon by relevant parties. In one particular, exemplary embodiment set forth above, an approved qualified investor may request the InvestCo 116 to exchange the first type of security in the InvestCo 116, which is one of stocks of a company, a limited liability company or a limited company, and one or more units in a partnership, a limited liability partnership or a limited partnership in relation to Project A, to stocks or shares of the ListCo 102. In one particular, exemplary embodiment set forth above, if an approved qualified investor who initially makes the first and second payments of V₁=$5,000, and V₂=$545,000, in five years, the approved qualified investor can request and obtain shares of the ListCo 102 with a market value of $650,000 in exchange for the approved qualified investor's first type securities. It is noted that because of the inherent risks and uncertainties in relation to a stock in an stock exchange, this exchange of securities is novel and legal. Thus, in general, the second type of security is stocks of the public company, wherein the public company is listed in a stock exchange of one of the first jurisdiction, the second jurisdiction, and a third jurisdiction. In one embodiment, the public company is listed in a stock exchange of China. Alternatively, the public company may also be listed in a stock exchange of Hong Kong.

At step 427, the computer server 219 checks if there is a second flag corresponding to an approved qualified investor who has made the request and the request would be granted only if there is a second flag corresponding to the approved qualified investor. Utilizing the second flag would greatly improve the efficiency as well as the accuracy of the accounting when a project has thousands of qualified investors to participate in.

At step 429, the second type of security of a public company in the first jurisdiction or another jurisdiction is delivered to said approved qualified investor whose records in the database 219b is marked with a second flag. Proper book entries are made then on the computer server 219 for said approved qualified investor and corresponding records of the book entries are stored in the database 219a for the delivery. The steps 425 and 427 can be repeated until all the requests from one or more approved qualified investors are processed.

For the convenience of the reader, the above description has focused on a representative sample of all possible embodiments, a sample that teaches the principles of the invention and conveys the best mode contemplated for carrying it out. The description has not attempted to exhaustively enumerate all possible variations. Further undescribed alternative embodiments are possible.

Thus, the foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method of facilitating international investment among different jurisdictions through a qualified immigration program, comprising the steps of:
(a) qualifying one or more investors from a first jurisdiction;
(b) receiving a first cash or cash equivalents payments in the amount of V₁ made by one or more qualified investors;
(c) making book entries on an internet accessible computer server for the cash or cash equivalents payments received and storing corresponding records of the book entries in a database coupled with the computer server;
(d) offering a first type of security to one or more qualified investors from the first jurisdiction by a first entity in a second jurisdiction that is different from the first jurisdiction;
(e) subscribing the first type of security by one or more qualified investors from the first jurisdiction or other jurisdictions that are not the second jurisdiction;
(f) receiving a second cash or cash equivalents payments in the amount of V₂ from the offering by the first entity, wherein the second cash or cash equivalents payments are made by said one or more qualified investors or their representatives, and wherein V₁, V₂ satisfy the following relationship:
V₁≦V₂, and V₁≦V₀≦V₂,
wherein V₀ is an amount that is predetermined by the government of the second jurisdiction;
(g) making book entries on a computer server for the second cash or cash equivalents payments received and storing corresponding records of the book entries in a database coupled with the computer server;
(h) investing a portion of the received cash or cash equivalents payments in the amount of V₀ for each qualified investor in a project in the second jurisdiction by the first entity;
(i) for each of said one or more qualified investors, applying for investment-based immigration program in the second jurisdiction allowed by the government of the second jurisdiction with a first petition;
(j) making book entries on the computer server for the first petition for each of said one or more qualified investors and storing corresponding records of the book entries in the database coupled with the computer server;
(k) if the first petition is disapproved by the government of the second jurisdiction for a qualified investor, making a cash or cash equivalents payment in the amount of V₂ to said disapproved qualified investor;
(l) making book entries on the computer server for the payment to said disapproved qualified investor and storing corresponding records of the book entries in the database with a first flag;
(m) if the first petition is approved by the government of the second jurisdiction for a qualified investor, making a second petition to the government of the second jurisdiction for said approved qualified investor;
(n) making book entries on the computer server for said approved qualified investor and storing corresponding records of the book entries in the database with a second flag;
(o) counting the total number of the second flag, F, by the computer server;
(p) periodically calculating by the computer server a total investment amount V by the following formula:
V=F×V₀;
(q) receiving request from one or more approved qualified investors to exchange the first security for a second type of security of a public company at a predetermined date;
(r) checking by the computer server if there is a second flag corresponding to an approved qualified investor who has made the request and granting the request only if there is a second flag corresponding to the approved qualified investor;
(s) delivering said second type of security of a public company in the first jurisdiction to said approved qualified investor;
(t) making book entries on the computer server for said approved qualified investor and storing corresponding records of the book entries in the database for the delivery; and
(u) repeating steps (r)-(t) until all the requests from one or more approved qualified investors are processed.

2. The method of claim 1, wherein the second jurisdiction is a country or region that has a government offering an investment-based immigration program, and the first jurisdiction is a country or region that is different from the first jurisdiction.

3. The method of claim 2, wherein the second jurisdiction is the United States, and the investment-based immigration program is the EB-5 program.

4. The method of claim 3, wherein the first jurisdiction is a country or region that is not the United States.

5. The method of claim 4, wherein the first jurisdiction is one of China, Russia, Mexico, India, South Korea, Taiwan, Dubai and Hong Kong.

6. The method of claim 4, wherein V₀ equals to one of $500,000 and $1,000,000.

7. The method of claim 4, wherein the first entity is one of a company, a partnership, a limited liability company, a limited liability partnership, a limited company, and a limited partnership.

8. The method of claim 7, wherein the first type of security is one of stocks of a company, a limited liability company or a limited company, and units in a partnership, a limited liability partnership or a limited partnership.

9. The method of claim 8, wherein the second type of security is stocks of the public company.

10. The method of claim 9, wherein the public company is listed in a stock exchange of one of the first jurisdiction, the second jurisdiction, and a third jurisdiction.

11. The method of claim 10, wherein the public company is listed in a stock exchange of China.

12. The method of claim 10, wherein the public company is listed in a stock exchange of Hong Kong.

13. The method of claim 6, wherein the first petition is an I-526 petition defined in the EB-5 program.

14. The method of claim 13, wherein the second petition is an I-829 petition defined in the EB-5 program.

15. The method of claim 6, wherein the predetermined date for an approved qualified investor corresponds to a date that is five (5) years from the date when the second cash or cash equivalents payments are made by said approved qualified investor or his or her representative.

16. The method of claim 2, wherein the second jurisdiction is one of Canada, Australia, New Zealand, and North Ireland.

17. An internet accessible computer system to facilitate international investment among different jurisdictions through a qualified immigration program, comprising:
(i) a first client system related to a public company;
(ii) a second client system related to a first entity;
(iii) at least one computer server coupled to a database for storing data; and
(iv) a network connecting said the first client system and the second client system to said at least one computer server, wherein said at least one computer server is programmed for:
(a) making book entries on an internet accessible computer server for a first cash or cash equivalents payments received in the amount of V₁ made by one or more investors from a first jurisdiction and storing corresponding records of the book entries in a database coupled with the computer server to qualify said one or more investors;
(b) after a first type of security is offered to one or more qualified investors from the first jurisdiction by the first entity in a second jurisdiction that is different from the first jurisdiction, making book entries through the second client system on the computer server and storing corresponding records of the book entries in the database coupled with the computer server;
(c) after the first type of security is subscribed by one or more qualified investors from the first jurisdiction, making book entries through the second client system on the computer server and storing corresponding records of the book entries in the database coupled with the computer server;
(d) after a second cash or cash equivalents payments in the amount of V₂ from the offering is received by the first entity, wherein the second cash or cash equivalents payments are made by said one or more qualified investors or their representatives, and wherein V₁, V₂ satisfy the following relationship:
V₁≦V₂, and V₁≦V₀≦V₂,
wherein V₀ is an amount that is predetermined by the government of the second jurisdiction, making book entries through the second client system on the computer server and storing corresponding records of the book entries in the database coupled with the computer server;
(e) after investing a portion of the received cash or cash equivalents payments in the amount of V₀ for each qualified investor in a project in the second jurisdiction by the first entity, and an application for each of said one or more qualified investors for investment-based immigration program in the second jurisdiction allowed by the government of the second jurisdiction is filed with a first petition, making book entries on the computer server for the first petition for each of said one or more qualified investors and storing corresponding records of the book entries in the database coupled with the computer server;
(f) after making a cash or cash equivalents payment in the amount of V₂ to said disapproved qualified investor if the first petition is disapproved by the government of the second jurisdiction for a qualified investor, making book entries on the computer server for the payment to said disapproved qualified investor and storing corresponding records of the book entries in the database with a first flag;
(g) after making a second petition to the government of the second jurisdiction for said approved qualified investor if the first petition is approved by the government of the second jurisdiction for a qualified investor, making book entries on the computer server for said approved qualified investor and storing corresponding records of the book entries in the database with a second flag;
(h) counting the total number of the second flag, F, by the computer server;
(i) periodically calculating by the computer server a total investment amount V by the following formula:
V=F×V₀;
(j) after receiving request from one or more approved qualified investors to exchange the first security for a second type of security of a public company at a predetermined date, checking by the computer server if there is a second flag corresponding to an approved qualified investor who has made the request and granting the request only if there is a second flag corresponding to the approved qualified investor;
(k) after said second type of security of a public company in the first jurisdiction is delivered to said approved qualified investor, making book entries on the computer server for said approved qualified investor and storing corresponding records of the book entries in the database for the delivery; and
(l) repeating steps (j) and (k) until all the requests from one or more approved qualified investors are processed.

18. The system of claim 17, wherein the second jurisdiction is a country or region that has a government offering an investment-based immigration program, and the first jurisdiction is a country or region that is different from the first jurisdiction.

19. The system of claim 18, wherein the second jurisdiction is the United States, and the investment-based immigration program is the EB-5 program.

20. The system of claim 19, wherein the first jurisdiction is a country or region that is not the United States.

21. The system of claim 20, wherein the first jurisdiction is one of China, Russia, Mexico, India, South Korea, Taiwan, Dubai and Hong Kong.

22. The system of claim 20, wherein V₀ equals to one of $500,000 and $1,000,000.

23. The system of claim 20, wherein the first entity is one of a company, a partnership, a limited liability company, a limited liability partnership, a limited company, and a limited partnership.

24. The system of claim 23, wherein the first type of security is one of stocks of a company, a limited liability company or a limited company, and units in a partnership, a limited liability partnership or a limited partnership.

25. The system of claim 24, wherein the second type of security is stocks of the public company.

26. The system of claim 25, wherein the public company is listed in a stock exchange of one of the first jurisdiction, the second jurisdiction, and a third jurisdiction.

27. The system of claim 26, wherein the public company is listed in a stock exchange of China.

28. The system of claim 26, wherein the public company is listed in a stock exchange of Hong Kong.

29. The system of claim 22, wherein the first petition is an I-526 petition defined in the EB-5 program.

30. The system of claim 29, wherein the second petition is an I-829 petition defined in the EB-5 program.

31. The system of claim 22, wherein the predetermined date for an approved qualified investor corresponds to a date that is five (5) years from the date when the second cash or cash equivalents payments are made by said approved qualified investor or his or her representative.

32. The system of claim 18, wherein the second jurisdiction is one of Canada, Australia, New Zealand, and North Ireland.

33. A method of facilitating international investment between different jurisdictions through a qualified immigration program, comprising the steps of:
(a) qualifying one or more investors from a first jurisdiction;
(b) receiving a first cash or cash equivalents payments in the amount of V₁ made by one or more qualified investors;
(c) offering a first type of security to one or more qualified investors from the first jurisdiction by a first entity in a second jurisdiction that is different from the first jurisdiction;
(d) providing the first type of security to one or more qualified investors from the first jurisdiction for subscription;
(e) receiving a second cash or cash equivalents payments in the amount of V₂ from the offering by the first entity, wherein the second cash or cash equivalents payments are made by said one or more qualified investors or their representatives, and wherein V₁, V₂ satisfy the following relationship:
V₁≦V₂, and V₁≦V₀≦V₂,
wherein V₀ is an amount that is predetermined by the government of the second jurisdiction;
(f) investing a portion of the received cash or cash equivalents payments in the amount of V₀ for each qualified investor in a project in the second jurisdiction by the first entity;
(g) for each of said one or more qualified investors, applying for investment-based immigration program in the second jurisdiction allowed by the government of the second jurisdiction with a first petition;
(h) if the first petition is disapproved by the government of the second jurisdiction for a qualified investor, making a cash or cash equivalents payment in the amount of V₂ to said disapproved qualified investor;
(i) making book entries on the computer server for the payment to said disapproved qualified investor and storing corresponding records of the book entries in the database with a first flag;
(j) if the first petition is approved by the government of the second jurisdiction for a qualified investor, making a second petition to the government of the second jurisdiction for said approved qualified investor;
(k) making book entries on the computer server for said approved qualified investor and storing corresponding records of the book entries in the database with a second flag;
(l) periodically calculating by the computer server a total investment amount V by the following formula:
V=F×V₀;
wherein F is the total number of the second flag counted by the computer server;
(m) after receiving request from one or more approved qualified investors to exchange the first security for a second type of security of a public company at a predetermined date, checking by the computer server if there is a second flag corresponding to an approved qualified investor who has made the request and granting the request only if there is a second flag corresponding to the approved qualified investor;
(n) delivering said second type of security of a public company in the first jurisdiction to said approved qualified investor;
(o) making book entries on the computer server for said approved qualified investor and storing corresponding records of the book entries in the database for the delivery; and
(p) repeating steps (m)-(o) until all the requests from one or more approved qualified investors are processed.

34. The method of claim 33, wherein the second jurisdiction is a country or region that has a government offering an investment-based immigration program, and the first jurisdiction is a country or region that is different from the first jurisdiction.

35. The method of claim 34, wherein the second jurisdiction is the United States, and the investment-based immigration program is the EB-5 program.

36. The method of claim 35, wherein the first jurisdiction is a country or region that is not the United States.

37. The method of claim 36, wherein the first jurisdiction is one of China, Russia, Mexico, India, South Korea, Taiwan, Dubai and Hong Kong.

38. The method of claim 36, wherein V₀ equals to one of $500,000 and $1,000,000.

39. The method of claim 36, wherein the first entity is one of a company, a partnership, a limited liability company, a limited liability partnership, a limited company, and a limited partnership.

40. The method of claim 39, wherein the first type of security comprises one of stocks of a company, a limited liability company or a limited company, and units in a partnership, a limited liability partnership or a limited partnership.

41. The method of claim 40, wherein the second type of security comprises stocks of the public company.

42. The method of claim 41, wherein the public company is listed in a stock exchange of one of the first jurisdiction, the second jurisdiction, and a third jurisdiction.

43. The method of claim 42, wherein the public company is listed in a stock exchange of China.

44. The method of claim 42, wherein the public company is listed in a stock exchange of Hong Kong.

45. The method of claim 48, wherein the first petition is an I-526 petition defined in the EB-5 program.

46. The method of claim 48, wherein the second petition is an I-829 petition defined in the EB-5 program.

47. The method of claim 48, wherein the predetermined date for an approved qualified investor corresponds to a date that is five (5) years from the date when the second cash or cash equivalents payments are made by said approved qualified investor or his or her representative.

48. The method of claim 34, wherein the second jurisdiction is one of Canada, Australia, New Zealand, and North Ireland.
